(19) United States
(12) Patent Application Publication
(10) Pub. No.: US 2012/0268285 A1
(43) Pub. Date: Oct. 25, 2012

(54) SYSTEMS AND METHODS FOR PROVIDING HAPTIC FEEDBACK IN A MEDICAL MONITOR

(75) Inventor: Bryan Hansen, Mead, CO (US)

(73) Assignee: Nellcor Puritan Bennett LLC, Boulder, CO (US)

(21) Appl. No.: 13/092,619

(22) Filed: Apr. 22, 2011

(51) Int. Cl. G08B 6/00

(52) U.S. Cl. 340/691.1

(57) ABSTRACT

The present disclosure is directed towards systems and methods for providing haptic feedback in a medical monitor. The haptic feedback may be configurable. For example, haptic feedback may be associated with only a defined set of events occurring or may have different properties according to the event that triggers the haptic feedback to occur.

The present disclosure is directed towards a medical monitor and, more particularly, the present disclosure is directed towards a medical monitor with a touch screen interface and haptic feedback.

### SUMMARY

The present disclosure is directed towards providing haptic feedback in a medical monitor. In some embodiments, haptic feedback may be provided in response to a user selecting an option from a touch screen display that is defined by the monitor as a critical or important option. For example, such selectable options may be related to changing alarm settings.

In some embodiments, properties of the haptic feedback generated by the monitor may be customized according to a category associated with an option selected by a user from the touch screen display.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a block diagram of a medical monitor system in accordance with some embodiments of the present disclosure;

FIG. 2 is a flow chart of illustrative steps involved in providing haptic feedback in connection with the selection of a critical option in accordance with some embodiments of the present disclosure;

FIG. 3 shows an illustrative table that defines associations between selectable options, option categories, and haptic feedback properties in accordance with some embodiments of the present disclosure; and

FIG. 4 is a flow chart of illustrative steps involved in providing haptic feedback having properties according to a user selected option in accordance with some embodiments of the present disclosure.

### DETAILED DESCRIPTION

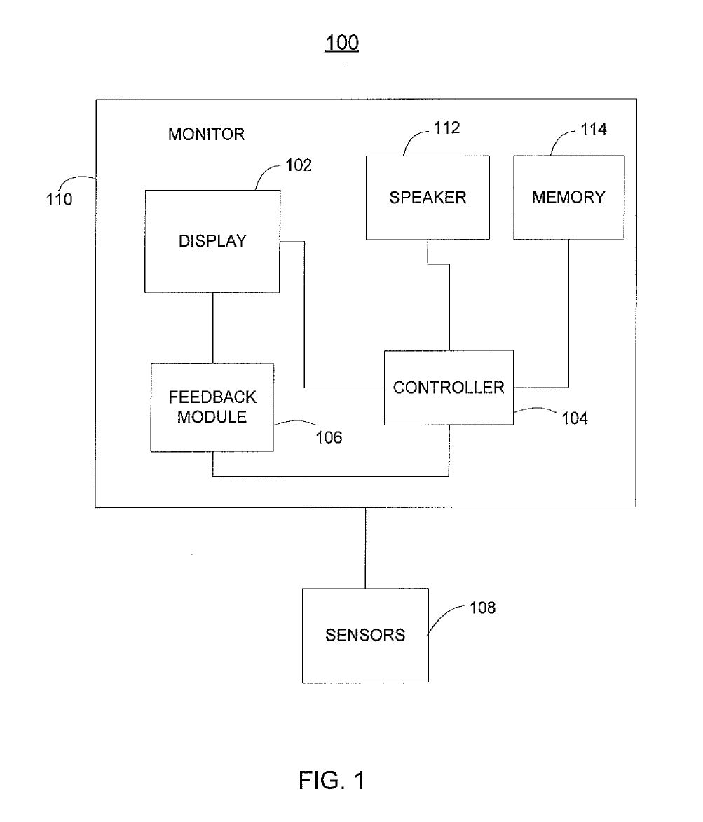

FIG. 1 is a block diagram of an illustrative medical monitoring system 100 in accordance with some embodiments of the present disclosure. Medical monitoring system may include a medical monitor device 110 coupled to one or more sensors 108. Sensors 108 may be attached to or otherwise engaged with a patient in order to obtain certain physiological signals from the patient for processing by monitor 110. Monitor 110 may be coupled to any other suitable computer, medical monitor, processing device, any other suitable device, or any combination thereof.

Monitor 110 may be, for example, a pulse oximeter, an electrocardiograph (ECG) monitor, an electroencephalogram (EEG) monitor, a blood pressure monitor, a respiration rate monitor, any other suitable monitor, or a multiparameter monitor that measures or calculates any combination of these or other parameters.

Monitor 110 may include a display 102. Display 102 may be any display device suitable for use in a medical monitor. In accordance with the present disclosure, display 102 is a touch sensitive display. The touch sensitive capabilities of display 102 may be implemented using any suitable technology including, for example, a resistive touchscreen, a capacitive touchscreen, an infrared touchscreen, an optical imaging based touchscreen, a dispersive signal touchscreen, an acoustic pulse recognition touchscreen, any other suitable touchscreen, or any combination thereof.

In some embodiments, monitor 110 may include multiple displays, any one or more of which may include the touch sensitive features of the present disclosure. For purposes of brevity and clarity, and not by way of limitation, the present disclosure is described in the context of a single display 102.

Display 102 may be coupled to a controller such as controller 104, which may be used to control a feedback module 106. Feedback module 106 may be any suitable combination of hardware and software for producing a haptic feedback in response to user interaction with monitor 110, such as interaction with display 102.

Controller 104 may be any suitable processing circuitry for controlling feedback module according to signals generated by display 102 responsive to user interactions with display 102. Controller 104 may be, for example, software executed on a central processing unit, a dedicated integrated circuit (e.g., ASIC or FPGA), any other suitable software, hardware, or both, or any combination thereof. Controller 104 may be internal to the chassis of monitor 110 or may be an external module, such as software running on an external computer coupled to monitor 110.

Feedback module 106 may be any suitable software, hardware, or both for producing a haptic (i.e., tactile) feedback in response to one or more control signals generated by controller 104. Feedback module 106 may include, for example, a mechanical device that generates a vibration or movement effect in response to an electromagnetic stimulus. Such mechanical devices may include, for example, a motor with a small weight, a disk or other object that is bounced or otherwise moved back and forth, any other suitable actuator for generating a vibration or movement, or any combination thereof. In some embodiments, feedback module 104 may include piezoelectric components that may provide haptic feedback.

Feedback module 106 may be arranged within or on monitor 110 in a way that provides sufficient haptic sensation to a user touching display 102. For example, feedback module 106 may be arranged such that it is in contact or close to display 102 in order to cause display 102 to vibrate. Alternatively, feedback module 106 may be arranged in or on any other portion of monitor 110 such that vibrations or movements actuated by feedback module 106 may be sensed by a user touching display 102 (e.g., the monitor as a whole may vibrate).

In some embodiments, feedback module 106 may be coupled directly to display 102 in addition to being coupled to display through controller 104. The direct coupling may be used to, for example, cause an activation of an actuating device in feedback module without processing the event by controller 104. For example, if a user presses on display 102, the pressure may be sensed by the touch sensitive components of display 102 causing an electrical signal to be generated and transmitted to feedback module 106, which will in turn activate an actuating device to cause, for example, a vibration.

Speaker 112 may be coupled to controller 104 to provide audio sounds to indicate, for example, alarm conditions. In some embodiments, speaker 112 may produce audio sounds in response to touch-activated activity by a user interacting with display 102. Speaker 102, or any other audio transducing device may be implemented as part of feedback module 106.

Memory 114 may be coupled to controller 104. Memory 114 may be any suitable memory that may include, for example, any suitable volatile memory, non-volatile memory, or both. Memory 114 may be solid state integrated circuit-based memory (e.g., SRAM, DRAM, EPROM, etc.), magnetic-based storage, optical-based storage, any other suitable type of storage device, or any combination thereof.

In some embodiments, the touch sensitive technology and properties of display 102 may be selected such that a user wearing gloves (e.g., surgical gloves in an operating room environment). For example, a resistive touch sensitive display may be used. In addition, to avoid inadvertent selections, an appropriate sensitivity level may be implemented for display 102. Haptic feedback provided by feedback module 106 and controller 104 may provide confirmation to the user that a selection from display 102 has been made. In addition to haptic feedback, other cues may be provided by monitor 110 to indicate that a selection has been made. These cues may be visual cues, audible cues, or both. In one suitable approach, selection of an on screen option may cause a vibration by feedback module 106, a sound to be played through speaker 112, a visual cue to appear on display 102 indicating that a selection has been made (e.g., highlighting an icon or object displayed on display 102), or any combination thereof. It will be understood that any discussion herein regarding a haptic feedback will implicitly include options to provide feedback using audio and/or visual cues as well.

In some embodiments, controller 104 may cause feedback module 106 to provide a haptic feedback if controller 104 determines that the user made a selection from display 102 in error (e.g., double-pressed an available option, selected an incorrect or unavailable option, any other incorrect selection, or any combination thereof).

In some embodiments, controller 104 may cause feedback module 106 to provide haptic feedback if controller 104 determines that the user made a valid selection from display 102. In these embodiments, monitor 110 may provide the user with a sensation or indication similar to having pressed a physical button. For example, when a selection is made by the user touching display 102, controller 104 may cause feedback module 106 to produce a short pulsed vibration that may imitate the feeling of pressing a button until it clicks. In addition, controller 104 may substantially simultaneously cause speaker 112 to output a click sound.

In some embodiments, controller 104 may cause feedback module 106 to provide haptic feedback in response to all or a subset of possible user interactions with touch sensitive display 102. For example, every time a selection is made by the user from display 102, a haptic feedback is generated. Alternatively, every time a particular type of selection is made (e.g., a specific option is selected), a haptic feedback is generated whereas for other selections, no haptic feedback is generated.

In connection with the latter type of implementation, in which haptic feedback is generated in response to only particular user selections, controller 104 may be configured to cause feedback module 106 to generate haptic feedback in response to user selection of what are categorized as critical or important selections. For example, a selection option to silence an alarm may be defined as a critical or important option. When an alarm is activated (e.g., audible, visual, or both), a selection option may appear on the screen to allow a user to silence, turn off, delay, or otherwise manipulate the alarm condition. Touching this selection option may cause monitor 110 to generate a haptic feedback in order to notify the user that a selection of a critical option was made. Other critical options may include, for example, options causing alarm limits to change, options for turning off alarms or otherwise changing alarm setting, options for changing settings related to drug or therapy delivery, options associated with communications with a central monitoring station, options for setting which physiological parameters to monitor (e.g., in a multiparameter system), any other suitable options, or any combination thereof.

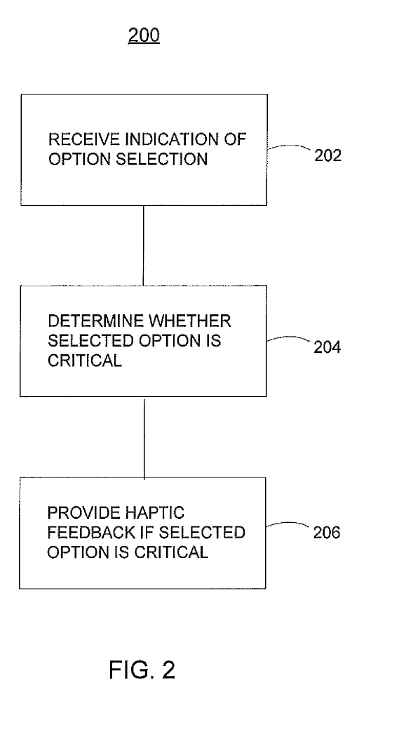

FIG. 2 is a flow chart 200 of illustrative steps involved in providing haptic feedback in connection with the selection of a critical option in accordance with some embodiments. At step 202, controller 104 may receive an indication of an option selection from display 102. At step 204, controller 104 may determine whether the selected option is categorized as a critical option. This may be implemented by, for example, accessing a look-up table in memory 114 (FIG. 2) in which selection options are associated with respective flags that indicate whether each option is critical, non-critical, or any other suitable designation. At step 206, if controller 104 determines that the selected option is critical, then controller 104 may cause feedback module 106 to generate a haptic feedback. It will be understood that while the present disclosure is described in the context of a critical selection option, haptic feedback may be generated in response to any other suitable one or more designations of selection options.

In some embodiments, controller 104 may cause feedback module 106 to generate different types of haptic feedback. That is, controller 104 may generate control signals indicative of a type of haptic feedback for feedback module 106 to generate. The type of haptic feedback may be determined according to any suitable criteria. For example, memory 114 may store different categories of selectable options. A look-up table may be stored that maps each selectable option to a category of selectable options, which, in turn, may be mapped to a respective type of haptic feedback, any other type of feedback (e.g., audible or visual), or any combination thereof. When a selectable option is selected by a user, controller 104 may determine the category of the selectable option by accessing, for example, the look up table from memory 114. The category may then be used to look up the appropriate type of haptic feedback, if any, from the memory. Controller 104 may then cause feedback module 106 to generate the type of feedback associated with the user selected option. In one suitable approach, each individual selectable option may be individually associated with a respective type of haptic feedback either in addition to or in place of option category associations.

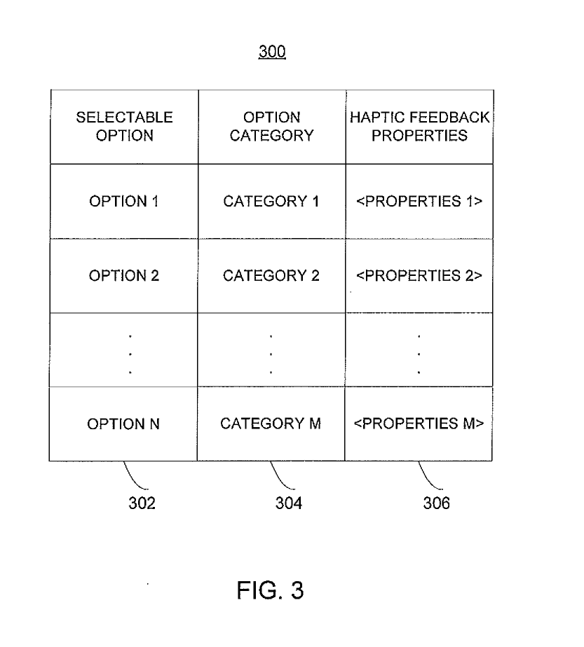

FIG. 3 shows an illustrative table 300 that defines associations between selectable options 302, option categories 304, and haptic feedback properties 306 in accordance with some embodiments of the present disclosure. The illustrated relationships may be stored in any suitable one or more data structures in memory 114 or in any suitable external device coupled to monitor 110. As discussed above, it will be understood that any suitable mapping of selectable options 302 to haptic feedback properties 306 may be used. Option categories 304 need not be included or defined in some embodiments.

Categories 304 may include any suitable category designations. For example, categories 304 may include any one or more of an alarm category, a monitor display interface category, a diagnostic category, a critical category, a non-critical category, a network communications category, a patient demographic category, any other suitable designation for categorizing options that may be selected by a user, types of user input (e.g., entering information using an on-screen keyboard/keypad, dragging items on the screen, etc.), or any combination thereof. It will be understood that the terms “option” and “selectable option” as used herein shall describe any type of interface component that may be selected or otherwise manipulated by a user using touch sensitive display 102.

Haptic feedback properties 306 may include any suitable one or more parameters that may be used by feedback module 106 in generating haptic feedback in which the parameters define certain characteristics of the haptic feedback. Examples of haptic feedback properties may include, for example, identification of one or more specific actuating devices to be used in generating the haptic feedback, vibration frequency information (e.g., a set frequency value, a range of frequency values, frequency modulation, or any combination thereof), vibration amplitude information (e.g., a set amplitude value, a range of amplitude values, amplitude modulation, or any combination thereof), directional information (e.g., directions in which actuating devices will move), time duration of haptic feedback, specific pattern of haptic feedback (e.g., a number of short pulses followed by a number of longer pulses), whether to generate haptic feedback, any other suitable properties, or any combination thereof.

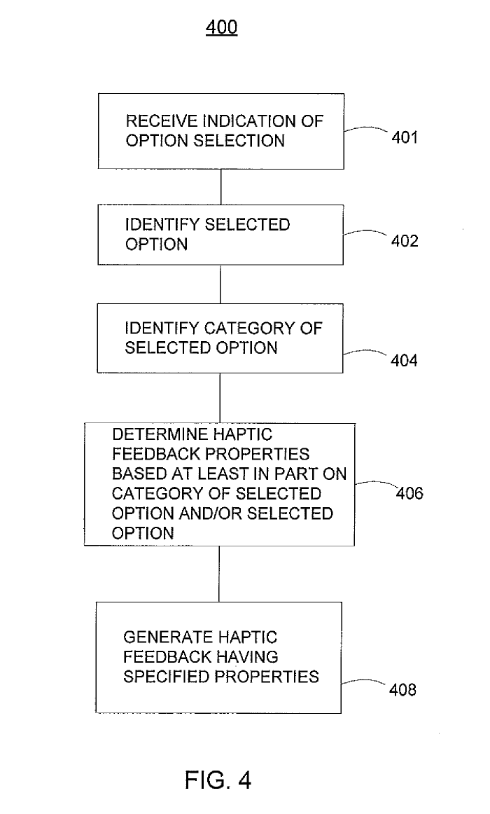

FIG. 4 is a flow chart 400 of illustrative steps involved in providing haptic feedback having properties according to a user selected option in accordance with some embodiments of the present disclosure. At step 401, controller 104 may receive an indication from, for example, display 102, of an option selection. At step 402, controller 104 may identify the option selected by the user on touch sensitive display 102. At step 404, controller 104 may access a look-up table stored in a memory to determine a category associated with the selected option. At step 406, controller 104 may access a look-up table stored in memory to determine haptic feedback properties based at least in part on the category associated with the selected option. In some embodiments, the identity of the selected option may also be used in determining haptic feedback properties. At step 408, feedback module 106 may generate a haptic feedback having the properties determined in step 406. It will be understood that any other suitable steps may be used in addition to or in place of those illustrated to implement a user selected option-based haptic feedback. Certain steps may also be omitted. For example, step 404 need not be used. Rather, in this type of embodiment, haptic feedback properties determined in step 406 may be based on the selected option as opposed to a category of the selected option.

It will be understood that in some embodiments, the haptic feedback of the present disclosure may be generated in response to events other than to a user selection of an option on a touch sensitive display. For example, haptic feedback may be generated as a result of the user pressing a physical button, turning a dial, disconnecting or connecting a sensor to the monitor or to the patient, or as a result of any other suitable event or condition occurring as determined by processing circuitry in the monitor (e.g., alarm condition, monitor error condition), any other suitable event or condition, or any combination thereof.

The methods described herein may be implemented using any human-readable or machine-readable instructions on any suitable system or apparatus, such as those described herein.

The foregoing is merely illustrative of the principles of this disclosure and various modifications can be made by those skilled in the art without departing from the scope and spirit of the disclosure. The above described embodiments are presented for purposes of illustration and not of limitation. The present disclosure also can take many forms other than those explicitly described herein. Accordingly, it is emphasized that the disclosure is not limited to the explicitly disclosed methods, systems, and apparatuses, but is intended to include variations to and modifications thereof which are within the spirit of the following claims.

What is claimed is:

1. A method for indicating selection of a critical option in a medical monitor having a touch sensitive display, the method comprising:
receiving an indication at processing circuitry that a selectable option displayed on the touch sensitive display has been selected;
determining using the processing circuitry whether the selected option is defined by the monitor as critical; and
providing haptic feedback using a feedback module if the selected option is critical.

2. The method of claim 1 wherein the determining whether the selected option is critical comprises determining whether the selected option affects one or more alarm related settings of the monitor.

3. The method of claim 2 wherein the alarm related settings are selected from the group consisting of alarm silence, alarm delay, alarm limits, and any combination thereof.

4. A method for providing haptic feedback in a medical monitor having a touch sensitive display, the method comprising:
receiving an indication at processing circuitry that a selectable option displayed on the touch sensitive display has been selected;
identifying with the processing circuitry a category associated with the selectable option;
determining with the processing circuitry haptic feedback properties based at least in part on the category; and
generating with a feedback module haptic feedback having the haptic feedback properties

5. The method of claim 4 wherein the identifying comprises retrieving information from a look-up table stored in a memory device in the monitor.

6. The method of claim 4 wherein the determining feedback properties comprises determining information from the group consisting of vibration amplitude information, vibration frequency information, directional information, feedback time duration information, feedback pattern information, and any combination thereof.

7. The method of claim 4 wherein the category is an alarm category.

8. The method of claim 4 wherein the category is representative of a type of user interaction with the display.

9. The method of claim 4 wherein the category is a representative of a type of the selectable option.

10. A medical monitor comprising
a touch sensitive display device;
a controller coupled to the touch sensitive display device configured to:
receive an indication that a selectable option displayed on the touch sensitive display has been selected,
determine whether the selected option is defined by the monitor as critical, and
output a control signal; and
a feedback module coupled to the controller configured to receive the control signal and to generate a haptic feedback in response to the control signal when the selected option is critical.

11. The monitor of claim 10 wherein the selected option is critical when the selected options are used to change alarms settings.

12. The monitor of claim 11 wherein the alarm related settings are selected from the group consisting of alarm silence, alarm delay, alarm limits, and any combination thereof.
